(19) United States
(12) Patent Application Publication
(10) Pub. No.: US 2009/0136222 A1
(43) Pub. Date: May 28, 2009

(54) METHOD AND SYSTEM FOR PHOTOGRAPHING MOVING PICTURES USING MULTIPLE PHOTOGRAPHING APPARATUSES

(75) Inventor: Sang-Hoon LEE, Daegu (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-city (KR)

(21) Appl. No.: 12/190,282

(22) Filed: Aug. 12, 2008

(30) Foreign Application Priority Data
Nov. 23, 2007 (KR) 10-2007-120449

(51) Int. Cl. G03B 17/00; G03B 41/00

(52) U.S. Cl. 396/59; 396/333

(57) ABSTRACT

A method and system for photographing moving pictures using a plurality of photographing apparatuses are provided. As part of the method and system, a master photographing apparatus is synchronized to at least one slave photographing apparatus and the master photographing apparatus captures moving pictures and transmits a moving picture capturing start signal to the slave photographing apparatus, upon receipt of a moving picture capturing request from a user. The slave photographing apparatus captures moving pictures according to the moving picture capturing start signal and transmits the captured moving pictures to the master photographing apparatus, and the master photographing apparatus displays the moving pictures transmitted by the slave photographing apparatus.

### PRIORITY

This application claims the benefit under 35 U.S.C. §119(a) of a Korean patent application filed in the Korean Intellectual Property Office on Nov. 23, 2007 and assigned Serial No. 2007-120449, the entire disclosure of which is hereby incorporated by reference.

### BACKGROUND OF THE INVENTION

1. Field of the Invention

The present invention generally relates to a method and system for photographing moving pictures. More particularly, the present invention relates to a method and system for photographing moving pictures using a plurality of photographing apparatuses.

2. Description of the Related Art

A Personal Area Network (PAN) is a network technology that can be used within a short range. In a PAN, electronic devices, such as TV, computers, mobile terminals, and Personal Digital Assistants (PDAs) within a short range are networked by a wireless connection to one another. Major examples of PAN-based functions include data transmission and reception between Bluetooth-enabled mobile terminals by Bluetooth and activation of electronic products like TV or audio by emitting a signal through Infrared Data Association (IrDA) communications. Besides Bluetooth and IrDA, the PAN may use many other wireless network technologies including Ultra WideBand (UWB) and Zigbee technologies. The PAN is widely used in computers, laptops, keyboards, headsets, camcorders, and cameras as well as mobile terminals. Especially for photographing apparatuses such as camcorders or cameras, the PAN provides a remote control function when moving pictures are captured.

Although the remote control function offers the benefit of remotely controlling the photographing of an object, when a user captures objects at different locations or wants images at different angles for the same object, the user should move a photographing apparatus to an intended location. Also, to store and edit captured moving pictures in a file, the user should transfer data to an external device such as a Personal Computer (PC) and edit them on the PC.

Accordingly, there exists a need for a technique for capturing moving pictures of different objects at different locations or moving pictures of an object captured from different angles and storing the captured moving pictures in a file without data transfer.

Also, portable terminals include the ability to display a moving picture signal since they have a camera or a receiver for receiving a digital broadcast (e.g. satellite digital broadcasting, terrestrial digital broadcasting, digital TV broadcasting, etc.).

Therefore, the portable terminals are enabled to execute a camera function for capturing, displaying, and transmitting an image of an object by a camera and a digital broadcasting output function for receiving and outputting a digital broadcast.

When a user requests the digital broadcasting output function while the camera function is in progress, a camera and digital broadcasting-enabled portable terminal should enter a digital broadcasting mode according to a user's menu input after terminating a preview mode in which the user previews an image of an object. The same thing occurs when the portable terminal switches from the digital broadcasting output function to the camera function.

The mode transition between the camera function and the digital broadcasting output function takes a plurality of key inputs from the user, thus causing an inconvenience to the user and an unnecessary time delay.

Therefore, a need exists for an improved method and system for photographing moving pictures using a plurality of photographing apparatuses.

### SUMMARY OF THE INVENTION

An aspect of the present invention is to address at least the above-mentioned problems and/or disadvantages and to provide at least the advantages described below. Accordingly, an aspect of the present invention is to provide a method and system for photographing moving pictures using a plurality of photographing apparatuses.

In accordance with an aspect of the present invention, a method for photographing moving pictures using a plurality of photographing apparatuses is provided. As part of the method, a master photographing apparatus is synchronized to at least one slave photographing apparatus. The master photographing apparatus captures moving pictures and transmits a moving picture capturing start signal to the slave photographing apparatus upon receipt of a moving picture capturing request from a user. The slave photographing apparatus captures moving pictures according to the moving picture capturing start signal and transmits the captured moving pictures to the master photographing apparatus. The master photographing apparatus displays the moving pictures transmitted by the slave photographing apparatus.

In accordance with another aspect of the present invention, a system for photographing moving pictures using a plurality of photographing apparatuses is provided. As part of the system, a master photographing apparatus captures and displays moving pictures and transmits a moving picture capturing start signal to a slave photographing apparatus. Upon receipt of a moving picture capturing request from a user while being synchronized to the slave photographing apparatus. The master photographing apparatus displays moving pictures received from the slave photographing apparatus upon receipt of a screen switching request from the user. The slave photographing apparatus captures moving pictures upon receipt of the moving picture capturing start signal from the master photographing apparatus while being synchronized to the master photographing apparatus and transmits the captured moving pictures to the master photographing apparatus.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a process of photographing moving pictures in a moving picture photographing system using a plurality of photographing apparatuses according to an exemplary embodiment of the present invention;

FIG. 2 is a block diagram of a photographing apparatus according to an exemplary embodiment of the present invention; and

FIG. 3 is a flowchart illustrating a method for photographing moving pictures between photographing apparatuses according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a method and system for photographing moving pictures using a plurality of photographing apparatuses capable of capturing moving pictures. More particularly, on the assumption that the present invention is implemented in the context of a PAN, a photographing apparatus that plays an active role is referred to as a “master” photographing apparatus and a photographing apparatus that plays a passive role is referred to as a “slave” photographing apparatus.

The master photographing apparatus captures moving pictures and receives moving pictures captured by at least one slave photographing apparatus synchronized to the master photographing apparatus over the PAN. The master and slave photographing apparatuses may capture the same or different objects.

Exemplary embodiments of the present invention also provide a method and system for, when a user requests screen switching, displaying or storing a moving picture captured and transmitted by a slave photographing apparatus in a master photographing apparatus and for storing moving pictures captured by the master and slave photographing apparatuses in a moving picture file without data transfer.

Thus, the user can display or record a moving picture captured by a photographing apparatus selected by the user's screen switching request using a moving picture captured by the master photographing apparatus that the user carries and a moving picture captured by at least one slave photographing apparatus apart from the master photographing apparatus, and can simply store the captured moving pictures in a moving picture file.

For this purpose, each photographing apparatus according to an exemplary embodiment of the present invention includes a camera module for receiving an image of an object and a wireless communication module for wirelessly transmitting and receiving signals and data to and from other photographing apparatuses over the PAN.

The wireless communication module may be a short-range wireless communication module such as Bluetooth, IrDA, Zigbee, UWB or the like. It may also be any other wireless communication module that can transmit and receive signals on a Wireless Local Area Network (WLAN) channel. The wireless communication module may be replaced by a wired communication module such as a Universal Serial Bus (USB).

A Bluetooth communication module operates on the unlicensed 2.4 to 2.4835 GHz (Industrial, Scientific and Medical (ISM)) frequency band that is commonly used all over the world. The Bluetooth wireless technology uses frequency hopping to prevent interference, Gaussian Frequency Shift Keying (GFSK) as a modulation scheme, and Time Division Duplex (TDD) for duplex communications. The Bluetooth communication module can transmit audio and video signals as well as data by digital modulation.

For frequency allocation, the Bluetooth wireless technology uses spectrum spreading by frequency hopping. Frequency hopping is a modulation of the waveforms of information in wireless communications by hopping a Bluetooth device at a rate of tens of hundreds of frequency hops per second. The resulting spectrum spreading prevents wave overlap. GFSK defined in the Bluetooth standard has excellent power efficiency, viable within a short range between a transmitter and a receiver.

Each photographing apparatus according to an exemplary embodiment of the present invention is assumed to be equipped with such a Bluetooth module. The Bluetooth-enabled photographing apparatus transmits and receives signals and data to and from other Bluetooth-enabled photographing apparatuses by Bluetooth communications. A moving picture captured by a user-selected photographing apparatus is displayed or recorded and captured moving pictures are stored in a moving picture file.

Before describing exemplary embodiments of the present invention, it is to be made clear that apparatuses for forming the system of the present invention are generically referred to as photographing apparatuses for better understanding of the present invention. However, it is to be understood that they can be of different types. That is, the photographing apparatuses may include a digital camera, a mobile terminal having a photographing function, and a multimedia device having a photographing function. Also, the photographing apparatuses that are synchronized using Bluetooth modules can be of different types in the system of an exemplary embodiment of the present invention.

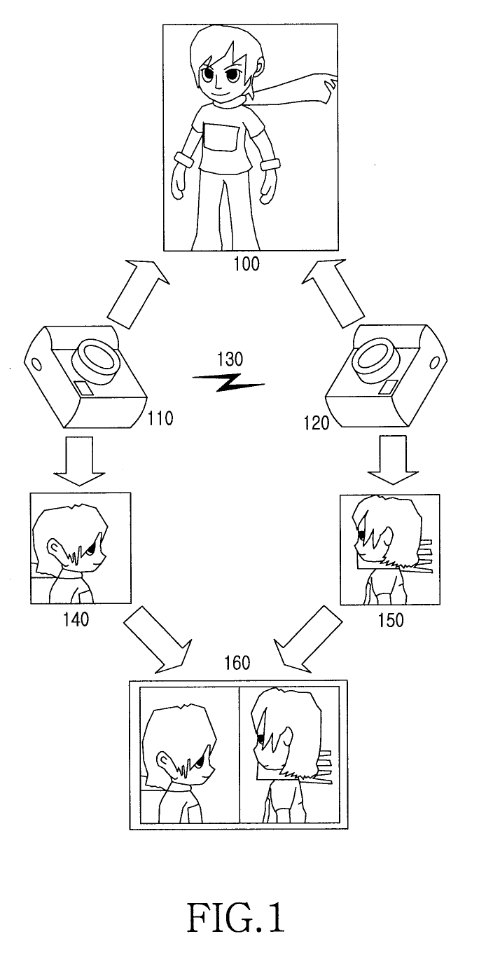

FIG. 1 illustrates a process of photographing moving pictures in a moving picture photographing system using a plurality of photographing apparatuses according to an exemplary embodiment of the present invention.

Referring to FIG. 1, the moving picture photographing system includes photographing apparatuses for capturing objects, for example, a master photographing apparatus 110 and a slave photographing apparatus 120. The master and slave photographing apparatuses 110 and 120 wirelessly communicate with each other, for example, by Bluetooth communications 130. While images illustrated in FIG. 1 appear to be still images, it is assumed that they are moving pictures.

When the master photographing apparatus 110 and the slave photographing apparatus 120 are synchronous to each other and thus are capable of transmitting and receiving signals and data by the Bluetooth communications 130, they capture a moving object 100 at their time instants and the slave photographing apparatus 120 transmits its captured moving picture 150 to the master photographing apparatus 110.

Upon user's request, either a moving picture 140 captured by the master photographing apparatus 110 or the moving picture 150 transmitted from the slave photographing apparatus 120 may be displayed on the master photographing apparatus 110. When the user requests screen switching, a moving picture captured by a photographing apparatus selected by the user can be displayed on the master photographing apparatus 110. In exemplary implementation, the master photographing apparatus 110 may simultaneously display its captured moving picture 140 and the moving picture 150 captured by the slave photographing apparatus 120, for example, on a screen 160.

The simultaneous displaying can be implemented in various forms such as Picture-In-Picture (PIP), Picture-Out-Picture (POP), or Picture-By-Picture (PBP). Or only the moving picture of a photographing apparatus selected by the user's screen switching request may be displayed.

Also, the moving pictures 140 and 150, respectively captured by the master and slave photographing apparatuses 110 and 120, can be temporarily recorded in a storage unit of the master photographing apparatus 110.

The master photographing apparatus 110 stores the moving pictures captured by the photographing apparatuses 110 and 120 in the form of a moving picture file, upon receipt of a request for generating a moving picture file from the user.

The master photographing apparatus 110 can store the moving pictures of the photographing apparatuses 110 and 120 selected by the user according to the user's screen switching request in a single moving picture file or in separate moving picture files. The stored moving picture file can be transmitted to the slave photographing apparatus 120 according to a user's request for transmitting the moving picture file so that they can be shared between the photographing apparatuses 110 and 120.

Even though two photographing apparatuses are shown in FIG. 1, a plurality of photographing apparatuses may be used in accordance with an exemplary embodiment of the present invention. That is, the main photographing apparatus 110 may be synchronized to a plurality of slave photographing apparatuses 120 to perform the above-described operation. In this case, a screen is divided according to the number of the master photographing apparatus 110 and the slave photographing apparatuses 120 and moving pictures transmitted from the slave photographing apparatuses 120 are displayed simultaneously in the screen parts in the master photographing apparatus 110. While the master and slave photographing apparatuses 110 and 120 capture moving pictures of the same object at different time instants in FIG. 1, the same thing applies to the case where they capture different objects at different locations.

Now a description will be made of the master and slave photographing apparatuses 110 and 120 in the system of an exemplary embodiment of the present invention.

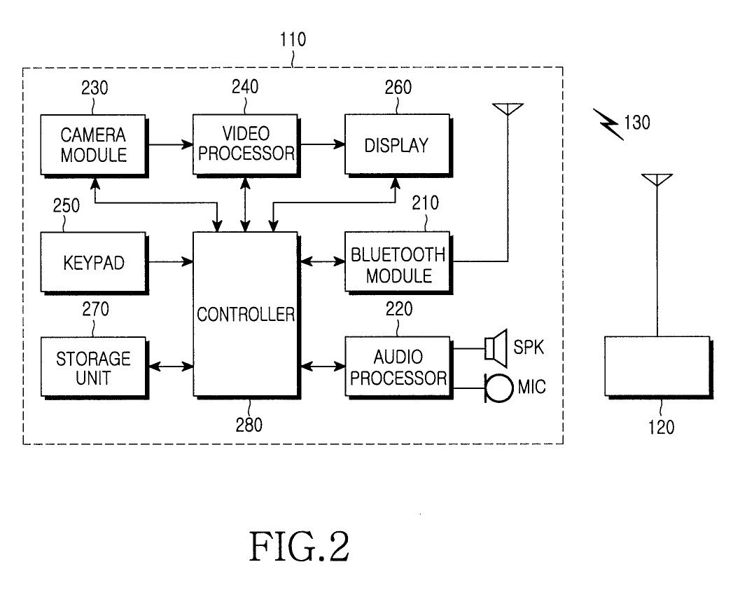

The master and slave photographing apparatuses 110 and 120 are substantially identical in configuration and function. Therefore, the master and slave photographing apparatuses 110 and 120 are called simply photographing apparatuses in the description of FIG. 2. Yet, the system is not necessarily configured with photographing apparatuses of the same type. It may be configured to include different types of photographing apparatuses each having the following components.

FIG. 2 is a block diagram of photographing apparatuses according to an exemplary embodiment of the present invention.

The photographing apparatus 110 includes a Bluetooth module 210, an audio processor 220, a camera module 230, a video processor 240, a keypad 250, a display 260, a storage unit 270, and a controller 280.

The Bluetooth module 210 performs the Bluetooth communications 130. While the photographing apparatuses 110 and 120 transmit and receive signals and data by the Bluetooth communications 130 using Bluetooth module 210 in accordance with the exemplary embodiment of the present invention, the present invention is not limited to Bluetooth communications. Hence, the Bluetooth module 210 may be replaced with a wireless communication device capable of wireless communications such as WLAN, IrDA, Zigbee, UWB or the like, or with a USB-based wired communication module.

The Bluetooth module 210 performs a series of operations including signal and data transmission and reception to and from Bluetooth-enabled devices via radio interfaces. In general, the Bluetooth module 210 includes a Bluetooth controller (not shown) for converting a signal and data for Bluetooth communications to Bluetooth packets or vice versa and a Bluetooth transceiver (not shown) for upconverting a packet received from the Bluetooth controller to a Radio Frequency (RF) signal or for downconverting a received RF signal to baseband data and for providing the baseband data to the Bluetooth controller. Also, the Bluetooth module 210 includes an antenna (ANT) for transmitting and receiving Bluetooth signals. Although the Bluetooth controller is included in the Bluetooth module 210, it may be configured to perform its function in the controller 280 of the photographing apparatus 110.

The audio processor 220 may be configured with a Coder and Decoder (CODEC). The CODEC may include a data CODEC for processing packet data and an audio CODEC for processing an audio signal such as voice. Hence, when a moving picture is taken, the audio processor 220 converts an analog audio signal received through a microphone (MIC) to digital audio data through the audio CODEC and provides the digital audio data to the controller 280. When a moving picture is reproduced, the audio processor 220 converts digital audio data to an analog audio signal through the audio CODEC and outputs the analog audio signal as audible sound through a speaker (SPK).

The camera module 230 captures an image through a lens. The camera module 230 includes a camera sensor (not shown) for converting a captured optical signal to an electrical signal and a signal processor (not shown) for converting an analog video signal received from the camera sensor to digital data. The camera sensor can be a Charge Coupled Device (CCD) sensor or a Complementary Metal-Oxide Semiconductor (CMOS) sensor and the signal processor can be a Digital Signal Processor (DSP), to which the present invention is not limited.

The video processor 240 processes a video signal received from the camera module 230 in frames and provides the resulting video data to the controller 280. It also converts the video data according to the display characteristics and screen size of the display 260 and provides the converted video data to the display 260. The video processor 240 compresses the video data and provides the compressed video data to the controller 280. For this operation, the video processor 240 includes a video CODEC for compressing video data to be displayed in a preset method or decompressing compressed video data to original video data. The video CODEC can be at least one of a Joint Photographic Experts Group (JPEG) CODEC, a Moving Picture Experts Group (MPEG) CODEC, and a Wavelet CODEC.

The keypad 250 receives a user's input signal and provides the received signal for controlling the photographing apparatus 110 to the controller 280. To do so, the keypad 250 may include a control key (not shown) for controlling operations of the photographing apparatus 110 and a plurality of alphanumerical keys (not shown) for entering digits and characters. In accordance with an exemplary embodiment of the present invention, the keypad 250 can have keys for the user to request photographing, screen switching, moving picture file generation, and moving file transfer.

If a single slave photographing apparatus 120 is used, a preset short key may be designated for the requesting of screen switching. If a plurality of slave photographing apparatuses 120 are used, the slave photographing apparatuses 120 are allocated to alphanumerical keys in the keypad 250 so that the user requests screen switching by selecting one of the slave photographing apparatuses 120 by pressing a key allocated to a corresponding slave photographing apparatus 120.

The display 260 displays an image captured by the camera module 230. The display 260 displays moving pictures captured by each of the photographing apparatuses 110 and 120 according to a screen switching request received from the keypad 250. A Liquid Crystal Display (LCD) can be used for the display 260. In this case, the display 260 may be provided with an LCD controller, a memory for storing data, and an LCD display device. Yet, the display 260 is not limited to an LCD and thus it can be any device with a display function such as an Organic Light Emitting Diode (OLED). If the display 260 is configured in the form of a touch screen, the screen of the display 260 can serve as a keypad. Then the keypad 250 may not be used.

The storage unit 270 includes a program memory and a data memory. The program memory stores programs for controlling general operations of the photographing apparatus 110. The data memory stores data generated during executing programs. In accordance with an exemplary embodiment of the present invention, the storage unit 270 records moving pictures captured by the camera module 230. The storage unit 270 can be provided within the photographing apparatus 110 or detachably mounted to the photographing apparatus 110 in the form of a memory card or the like.

The controller 280 provides overall control to the photographing apparatus 110. The controller 280 receives captured moving pictures including signals and data required for the Bluetooth communications 130 and carries out a series of operations for generating a moving picture file using the moving pictures.

Also, the controller 280 may have the function of controlling the Bluetooth communications 130 between the photographing apparatuses 110 and 120 through the Bluetooth module 210. Alternatively, the controller 280 itself can control the Bluetooth communications 130.

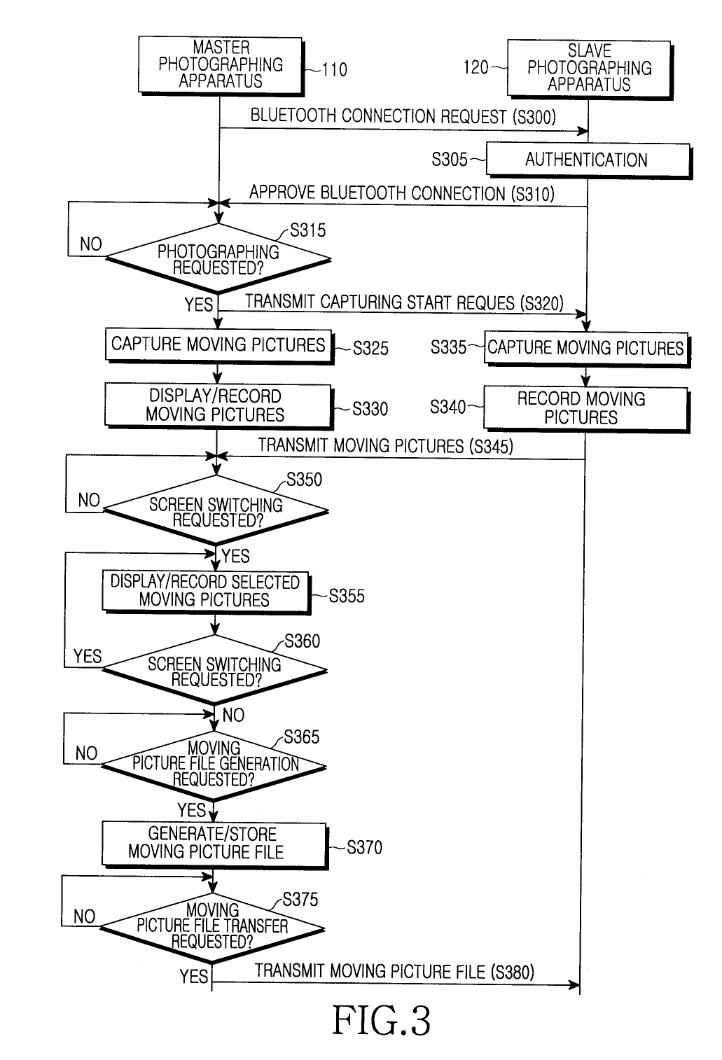

FIG. 3 is a flowchart illustrating a method for photographing moving pictures between photographing apparatuses according to an exemplary embodiment of the present invention.

In the method of FIG. 3, the master photographing apparatus 110 and the slave photographing apparatus 120 are connected using a preset authentication procedure, for example synchronization by Bluetooth connectivity. The authentication procedure may be performed in the master photographing apparatus 110 or the slave photographing apparatus 120.

Referring to FIG. 3, the master photographing apparatus 110 requests a Bluetooth connection, for example, to the slave photographing apparatus 120 over the PAN in step S300. In step S305, the slave photographing apparatus 120 performs a preset authentication procedure for a connection between the master and slave photographing apparatuses 110 and 120. A detailed description of the authentication procedure is omitted herein for clarity and conciseness.

Upon completion of the authentication, the slave photographing apparatus 120 notifies the master photographing apparatus 110 that the Bluetooth connection has been approved in step S310.

Meanwhile, while not shown in FIG. 3, the master photographing apparatus 110 may discover the existence of the slave photographing apparatus 120 around it in step S300. That is, the master photographing apparatus 110 determines whether the slave photographing apparatus 120 has been discovered when requesting the Bluetooth connection in step S300. In the absence of the slave photographing apparatus 120, the master photographing apparatus 110 outputs a notification message indicating the absence of any slave photographing apparatus 120 and terminates or continues the discovery according to a user's request. Also, the discovery can be done for a preset period of time. If the existence of the slave photographing apparatus 120 is notified to the user or no slave photographing apparatus 120 is found for the preset period of time, the discovery can be terminated automatically along with output of the notification message. On the other hand, in the presence of the slave photographing apparatus 120, the authentication procedure can be performed in step S305.

While not shown in FIG. 3, if the authentication is failed in step S305, the slave photographing apparatus 120 may notify the master photographing apparatus 110 of the failure of the Bluetooth connection between the master and slave photographing apparatuses 110 and 120 and thus the master photographing apparatus 110 can output a notification message indicating the failed Bluetooth connection to the user.

When the master photographing apparatus 110 receives a Bluetooth connection approval signal from the slave photographing apparatus 120 in step S310, they are synchronized to each other and capable of transmitting and receiving signals and data.

Then the master photographing apparatus 110 monitors reception of a moving picture capturing request from the user in step S315. Upon receipt of the moving picture capturing request, the master photographing apparatus 110 captures moving pictures in step S325 and records them in step S330. The master photographing apparatus 110 also transmits a capturing start request to the slave photographing apparatus 120 in step S320. Thus, the slave photographing apparatus 120 captures moving pictures in step S335, records them in step S340, and transmits the recorded moving pictures to the master photographing apparatus 110 in step S345.

The master photographing apparatus 110 can be so configured as to transmit the capturing start request to the slave photographing apparatus 120 simultaneously with reception of the moving picture capturing request from the user, so that the photographing occurs at the same time in the master and slave photographing apparatuses 110 and 120. Also, the slave photographing apparatus 120 can transmit the captured moving pictures to the master photographing apparatus 110 in real time without step S340 in step S345, or can temporarily record the captured moving pictures and transmit them according to the performance of the slave photographing apparatus 120 in step S345.

Upon receipt of a screen switching request from the user in step S350, the master photographing apparatus 110 displays and records the moving pictures received from the slave photographing apparatus 120 in step S355.

It can be further contemplated that the moving pictures captured by the master and slave photographing apparatuses 110 and 120 are displayed at the same time in PIP, PBP, POP, or screen division, for example.

In addition, upon receipt of the screen switching request from the user in step S350, the master photographing apparatus 110 may discontinue displaying its captured moving pictures and instead, display only the moving pictures received from the slave photographing apparatus 120.

Upon receipt of the screen switching request again during displaying the moving pictures captured by the slave photographing apparatus 120 in step S360, the master photographing apparatus 110 returns to step S355 in which it displays and records its captured moving pictures. That is, step S355 can be repeated according to the user's request during capturing moving pictures.

Steps 350, 355 and 360 are for screen switching between two photographing apparatuses. Even when a plurality of slave photographing apparatuses 120 exist, the master photographing apparatus 110 switches the screen to moving pictures captured by a user-selected slave photographing apparatus 120 and displays and records them.

Upon receipt of a moving picture generation request from the user in step S365, the master photographing apparatus 110 stores its captured moving pictures and the moving pictures captured by the slave photographing apparatus 120 selected by the user's screen switching request in the form of a moving picture file by concatenating them in step S370. The moving pictures can be stored in a single moving picture file by concatenating them or in separate moving picture files.

Upon receipt of a moving picture transfer request from the user in step S375, the master photographing apparatus 110 shares the stored moving picture file with the slave photographing apparatus 120 by transmitting the moving picture file to the slave photographing apparatus 120 in step S380.

As is apparent from the above description, exemplary embodiments of the present invention may synchronize a master photographing apparatus to a slave photographing apparatus, that is, synchronize a plurality of photographing apparatuses, selectively display or record moving pictures captured by a photographing apparatus selected according to a user's screen switching request, and store moving pictures captured by the master and slave photographing apparatuses in the form of a file.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for photographing moving pictures using a plurality of photographing apparatuses, the method comprising:
synchronizing a master photographing apparatus to at least one slave photographing apparatus;
capturing moving pictures and transmitting a moving picture capturing start signal to the slave photographing apparatus by the master photographing apparatus, upon receipt of a moving picture capturing request from a user;
capturing moving pictures according to the moving picture capturing start signal and transmitting the captured moving pictures to the master photographing apparatus by the slave photographing apparatus; and
displaying the moving pictures transmitted by the slave photographing apparatus in the master photographing apparatus.

2. The method of claim 1, wherein the displaying of the moving pictures comprises displaying the moving pictures transmitted by the slave photographing apparatus in the master photographing apparatus when the user requests screen switching.

3. The method of claim 1, wherein the transmitting of the captured moving picture comprises transmitting the captured moving pictures to the master photographing apparatus in real time by the slave photographing apparatus.

4. The method of claim 1, wherein the displaying of the moving pictures comprises simultaneously displaying the moving pictures transmitted by the slave photographing apparatus and the moving pictures captured by the master photographing apparatus.

5. The method of claim 4, wherein the displaying of the moving pictures comprises simultaneously displaying the moving pictures transmitted by the slave photographing apparatus and the moving pictures captured by the master photographing apparatus in at least one of Picture-In-Picture (PIP), Picture-Out-Picture (POP), and Picture-By-Picture (PBP).

6. The method of claim 4, wherein if a plurality of slave photographing apparatuses are used, the displaying of the moving pictures comprises displaying moving pictures captured by a slave photographing apparatus selected by the user.

7. The method of claim 4, wherein if a plurality of slave photographing apparatuses are used, the displaying of the moving pictures comprises dividing a screen according to the number of the master photographing apparatus and the slave photographing apparatuses and simultaneously displaying moving pictures captured by the slave photographing apparatuses and the moving pictures captured by the master photographing apparatus in the divided screen.

8. The method of claim 1, wherein the synchronizing of the master photographing apparatus comprises synchronizing the master photographing apparatus to the at least one slave photographing apparatus using a Personal Area Network (PAN).

9. The method of claim 1, wherein the synchronizing of the master photographing apparatus comprises synchronizing by using at least one of Bluetooth, Wireless Local Area Network (WLAN), Infrared Data Association (IrDA), Zigbee and Ultra WideBand (UWB) communications.

10. The method of claim 1, wherein the master photographing apparatus and the slave photographing apparatus capture the same object.

11. The method of claim 1, further comprising:
storing the moving pictures captured by the master photographing apparatus, when the user requests moving picture file generation;
discontinuing storing of the moving pictures captured by the master photographing apparatus, when the user requests screen switching; and
storing the moving pictures captured by the master photographing apparatus and the slave photographing apparatus in a moving picture file by concatenating the moving pictures captured by the master photographing apparatus to the moving pictures captured by the slave photographing apparatus.

12. The method of claim 11, further comprising, when the user requests a transfer of the moving picture file, transmitting the stored moving picture file to the slave photographing apparatus.

13. A system for photographing moving pictures using a plurality of photographing apparatuses, the system comprising:
a master photographing apparatus for capturing and displaying moving pictures and transmitting a moving picture capturing start signal to a slave photographing apparatus, upon receipt of a moving picture capturing request from a user while being synchronized to the slave photographing apparatus, and for displaying moving pictures received from the slave photographing apparatus, upon receipt of a screen switching request from the user; and
the slave photographing apparatus for capturing moving pictures, upon receipt of the moving picture capturing start signal from the master photographing apparatus while being synchronized to the master photographing apparatus and for transmitting the captured moving pictures to the master photographing apparatus.

14. The system of claim 13, wherein the slave photographing apparatus transmits the captured moving pictures to the master photographing apparatus in real time.

15. The system of claim 13, wherein the moving pictures captured by the slave photographing apparatus and the moving pictures captured by the master photographing apparatus are displayed simultaneously.

16. The system of claim 15, wherein the moving pictures captured by the slave photographing apparatus and the moving pictures captured by the master photographing apparatus are displayed simultaneously in at least one of Picture-In-Picture (PIP), Picture-Out-Picture (POP), and Picture-By-Picture (PBP).

17. The system of claim 15, wherein if a plurality of slave photographing apparatuses are used, the master photographing apparatus displays moving pictures captured by a slave photographing apparatus selected by the user.

18. The system of claim 15, wherein if a plurality of slave photographing apparatuses are used, the master photographing apparatus divides a screen according to the number of the master photographing apparatus and the slave photographing apparatuses and simultaneously displays the moving pictures captured by the slave photographing apparatuses and the moving pictures captured by the master photographing apparatus in the divided screen.

19. The system of claim 13, wherein the master photographing apparatus is synchronized to the slave photographing apparatus using a Personal Area Network (PAN).

20. The system of claim 13, wherein the master photographing apparatus and the slave photographing apparatus capture the same object.

21. The system of claim 13, wherein the master photographing apparatus stores the moving pictures captured by the master photographing apparatus, discontinues storing of the moving pictures captured by the master photographing apparatus, upon receipt of a screen switching request from the user, and stores the moving pictures captured by the master photographing apparatus and the slave photographing apparatus in a moving picture file by concatenating the moving pictures captured by the master photographing apparatus to the moving pictures captured by the slave photographing apparatus.

22. The system of claim 21, wherein when the user requests a transfer of the moving picture file, the master photographing apparatus transmits the stored moving picture file to the slave photographing apparatus.
